(19) United States
(12) Patent Application Publication
(10) Pub. No.: US 2010/0027292 A1
(43) Pub. Date: Feb. 4, 2010

(54) LIGHT GUIDING STRUCTURE

(76) Inventor: Yun-Yuan YEH, Sindian City (TW)

Correspondence Address: SINORICA, LLC, 2275 Research Blvd., Suite 500, ROCKVILLE, MD, 20850, US

(21) Appl. No.: 12/181,366

(22) Filed: Jul. 29, 2008

(51) Int. Cl. F21V 7/04

(52) U.S. Cl. 362/615; 362/612

(57) ABSTRACT

The present invention relates to a light guiding structure, comprises: a printed circuit board for carrying following units; a light guiding column retained on the printed circuit board; at least one light-emitting member disposed on the printed circuit board and provided beside the light guiding column, and lights emitted by the light-emitting member can be refracted or reflected by the light guiding column for increasing the brightness of lateral light emitting.

### BACKGROUND OF THE INVENTION

1. Field of the Invention

The present invention relates to a light guiding structure, more particularly to a light guiding structure in which a transparent or a semi-transparent light guiding column is served to refract or reflect lights emitted by at least one LED provided at the periphery of the light guiding column for enhancing the light emitting effect on the lateral side.

2. Description of Related Art

A conventional warning device seen in the marketplace is mostly equipped with one or more light bulbs, and a light-shielding back plate is provided behind the light bulbs for reflecting lights, so lights served as warning signs can be seen from every angle. The disadvantage of the above art is that a light bulb consumes large amount of electricity so a LED is served to replace the light bulb.

The light-emitting angle of a LED is frontally oriented and the light-emitting angle is above 120 degree, but the directivity of the lights emitted by the LED is high, in other words the frontal light beams emitted by the LED is bright and the lateral light beams emitted by the LED is relatively dark, thus lights at the lateral side become insufficient. The insufficiency shall be improved,

### SUMMARY OF THE INVENTION

One object of the present invention is to overcome disadvantages of conventional warning devices and to provide a light guiding structure in which a transparent or a semi-transparent light guiding column is served to refract or reflect lights emitted by at least one LED provided at the periphery of the light guiding column for enhancing the light emitting effect on the lateral side.

A light guiding structure provided by the present invention comprises, a printed circuit board for carrying following units; a light guiding column retained on the printed circuit board; at least one light-emitting member disposed on the printed circuit board and provided beside the light guiding column, and lights emitted by the light-emitting member can be refracted or reflected by the light guiding column.

In the light guiding structure mentioned above, the light guiding column is substantially provided at the center of the printed circuit board.

In the light guiding structure mentioned above, the light guiding column is transparent or semi-transparent, and a screw hole having screw threads is provided at the bottom end of the light guiding column, so a screw can be served to retain the light guiding column on the printed circuit board.

In the light guiding structure mentioned above, the light guiding column is a round column or a polygonal column, an arc-shaped surface is respectively defined at two ends of the middle portion of the light guiding column, and the arc-shaped surface has a top section.

In the light guiding structure mentioned above, the top section is in a cone shape, or in a cone shape and the top end of the top section is cut so a plane is defined, or in a round-column shape or in a round-column shape and the top end of the top section is provided with plural cut angles.

In the light guiding structure mentioned above, the arc-shaped surface and the top section are provided with a diamond structure having plural cut angles for refracting or reflecting lights.

In the light guiding structure mentioned above, the quantity of the light-emitting member is three and the three light-emitting members are respectively disposed at the periphery of the light guiding column with an equal interval.

In the light guiding structure mentioned above, the light-emitting member is a LED.

In the light guiding structure mentioned above, the light guiding structure is further provided with a lamp seat and a lampshade, wherein the lamp seat is served to retain the printed circuit board and the lampshade is served to cover on top of the printed circuit board and the lamp seat, so the lampshade is not only served to allow lights emitting out but also served to protect the light guiding structure.

### BRIEF DESCRIPTION OF THE DRAWINGS

FIG. 1 is an exploded view of the light guiding structure provided by the present invention;

FIG. 2a is a schematic view of a light guiding column of an embodiment of the present invention;

FIG. 2b is a schematic view of a light guiding column of an embodiment of the present invention;

FIG. 2c is a schematic view of a light guiding column of an embodiment of the present invention;

FIG. 2d is a schematic view of a light guiding column of an embodiment of the present invention;

FIG. 3 is a schematic view of a light guiding column being provided with a diamond structure having plural cut angles on the round surface of the top section;

FIG. 4 is a schematic view of the assembly of the light guiding structure provided by the present invention;

FIG. 5 is a schematic view of the assembly of the light guiding structure being further provided with a lampshade.

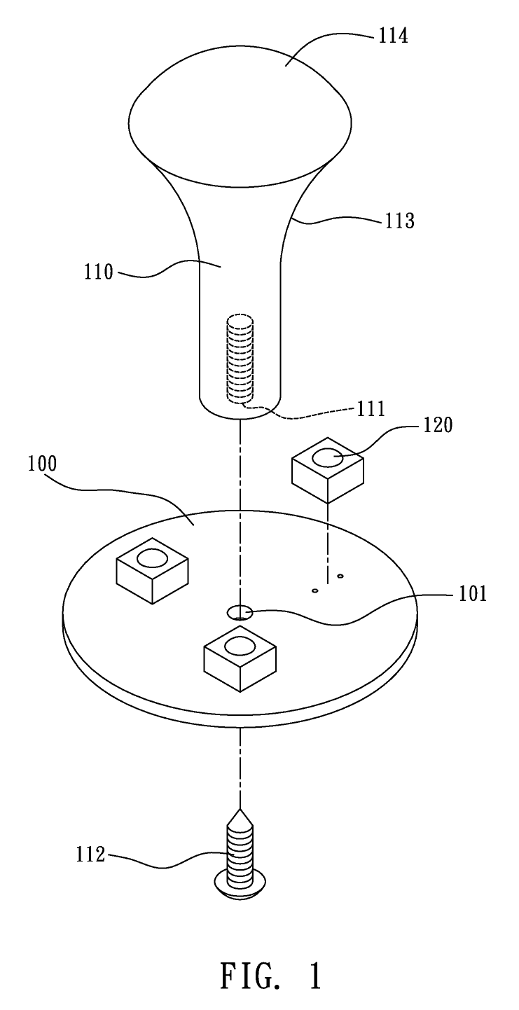

### DETAILED DESCRIPTION OF THE PREFERRED EMBODIMENT

As shown in figures, the light guiding structure provided by the present invention can be adopted in a lighting or a warning device; a warning device is served in this embodiment for illustration. The light guiding structure provided by the present invention comprises: a printed circuit board 100; a light guiding column 110; and at least one light-emitting member 120.

The printed circuit board 100 is served to carry the light guiding column 110 and the light-emitting member 120, the shape of the printed circuit board 100 can be varied according to actual needs; as shown in figures, the round-shaped printed circuit board 100 is served in this embodiment for illustration and the substantial center of the printed circuit board 100 has a round hole 101.

The column member of the light guiding column 110 is a round column or a polygonal column, the light guiding column 110 having a round column member is adopted in this embodiment for illustration, and the light guiding column 110 can be retained on the printed circuit board 100, e.g. but not limited to being provided at the substantial center of the printed circuit board 100; the light guiding column 110 is served to refract or reflect light beams emitted by the light-emitting member 120. The light guiding column 110 is transparent or semi-transparent and the bottom end of the light guiding column 110 has a screw hole 111 having screw threads (not shown), so the light guiding column 110 can be retained on the printed circuit board 100 via a screw 112 passing through the round hole 101 and the screw hole 111.

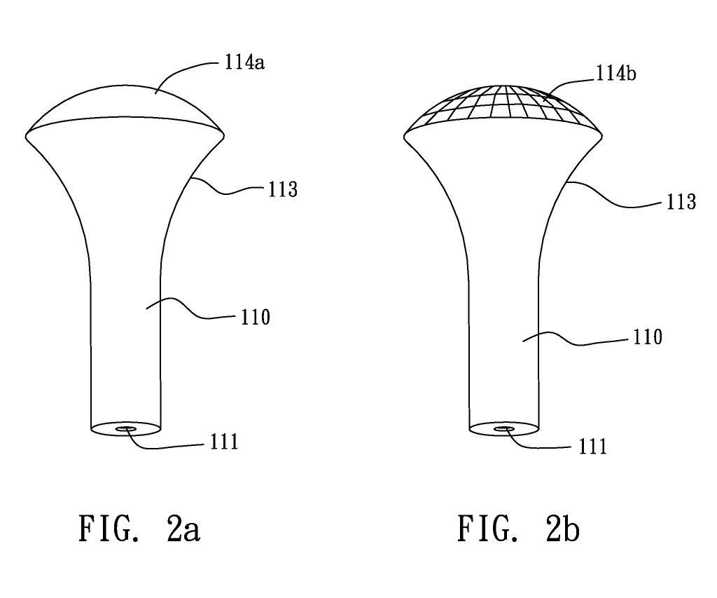

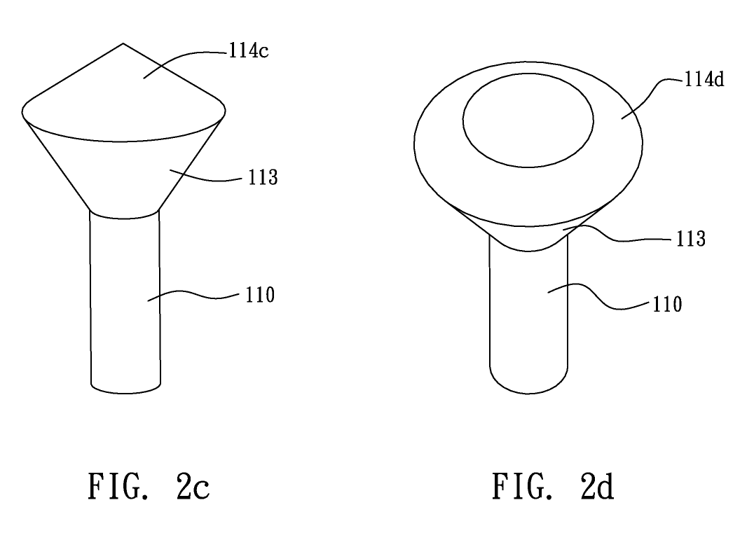

As shown from FIG. 2a to FIG. 2d, two ends of the middle portion of the light guiding column 110 is respectively provided with an arc-shaped surface 113 that is gradually expended, the arc-shaped surface 113 has a top section, the top section is in, e.g. but not limited to, a round column shape 114a (referring to FIG. 2a) or a round column shape having plural cut angles 114b (referring to FIG. 2b), a cone shape 114c (referring to FIG. 2c) or a cone shape whose top surface is cut so a plane is defined 114d (referring to FIG. 2d); so the arc-shaped surface 113 and the surface 114a, 114b, 114c or 114d can be served to enhance the refraction or the reflection of the light beams for increasing the brightness of lateral light emitting.

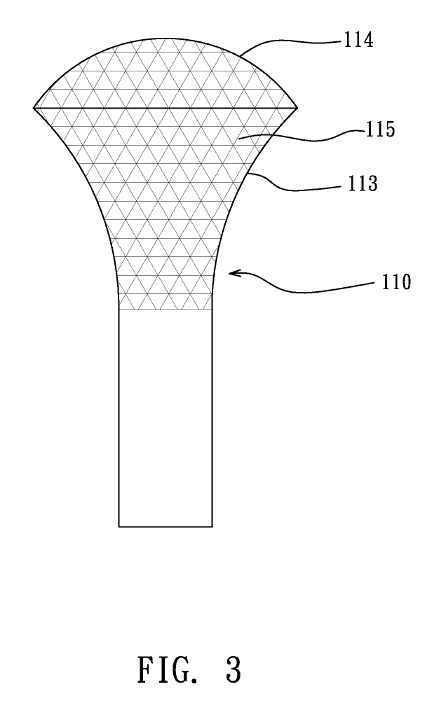

As shown in FIG. 3, the arc-shaped surface 113 of the light guiding column 110 and the surface 114a, 114b, 114c or 114d are provided with a diamond structure 115 having plural cut angles; the round surface 114a is adopted in this embodiment for illustration, the diamond structure 115 having plural cut angles is served to refract or reflect the light beams from various angles for increasing the brightness of lateral light emitting.

The light-emitting member 120 is, but not limited to, a LED, and preferably is a surface mount device (SMD) LED, the SMD LED is adopted in this embodiment for illustration, the light-emitting member 120 is disposed on the printed circuit board 100 and is provided beside the light guiding column 110, lights emitted from the light-emitting member 120 can be refracted or reflected by the light guiding column 110. The quantity of the light-emitting member 120 is varied according to actual needs, and the quantity of three is adopted in this embodiment for illustration, the three light-emitting members 120 are respectively provided at the periphery of the light guiding column 110 with an equal interval, so the visible light beams from various angles are more unified.

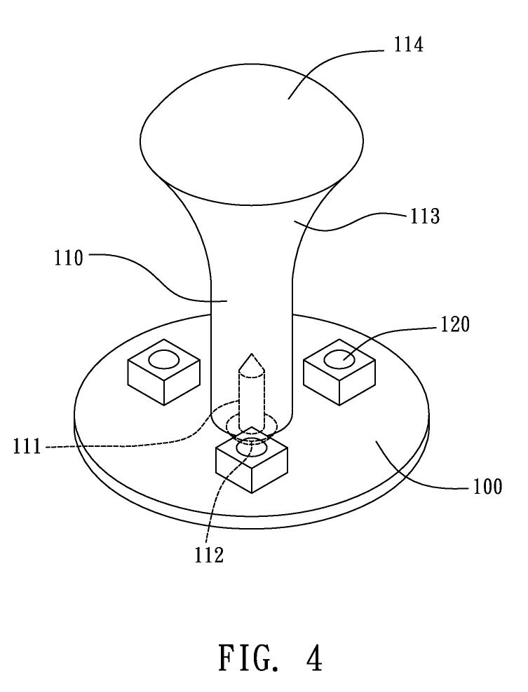

As shown in FIG. 4, the operation of the light guiding structure provided by the present invention is that: when an external power is transferred to the three light-emitting members 120 via the printed circuit board 100, light beams are respectively and uprightly emitted by the light-emitting members 120, and the light beams are refracted or reflected by the arc-shaped surface 113 of the light guiding column 110 and the surface 114a, 114b, 114c or 114d, thus part of the light beams are guided to laterally emit for increasing the brightness of lateral light emitting.

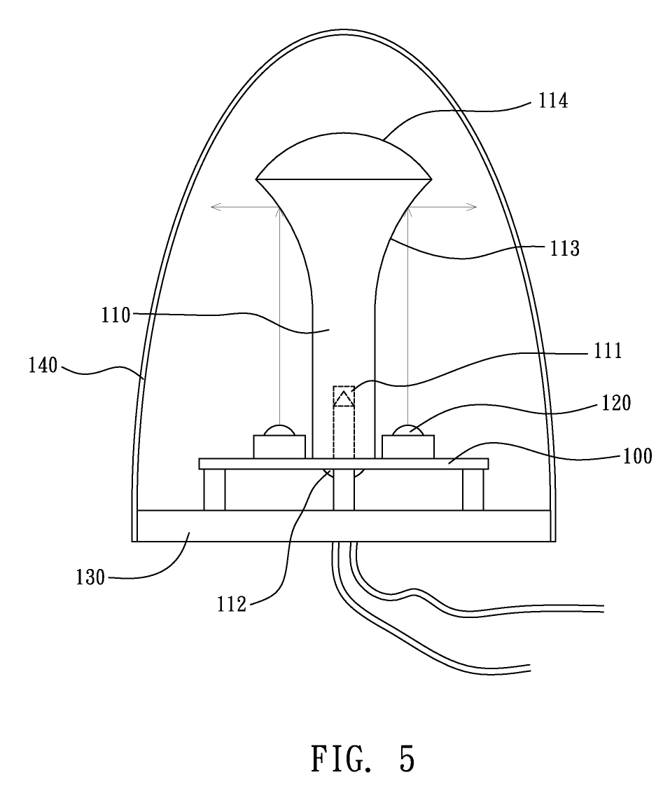

As shown in FIG. 5, for protecting the printed circuit board 100, the light guiding column 110 and the light-emitting members 120, the light guiding structure provided by the present invention is further provided with a lamp seat 130 and a lampshade 140, wherein the lamp seat 130 is served to retain the printed circuit board 100 and the lampshade 140 is in an egg-like shape and is made of, e.g. but not limited to, a transparent plastic material, and the lampshade 140 is served to cover on top of the printed circuit board 100 and the lamp seat 130, so the lampshade 140 is not only served to allow lights emitting out but also served to protect the light guiding structure.

In the light guiding structure provided by the present invention, a transparent or a semi-transparent light guiding column is provided and at least one LED is provided at the periphery of the light guiding column, so lights can be refracted or reflected by the light guiding column, the effect of increasing brightness of lateral light emitting is achieved.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light guiding structure, comprises:
a printed circuit board for carrying following units;
a light guiding column retained on the printed circuit board;
at least one light-emitting member disposed on the printed circuit board and provided beside the light guiding column, and lights emitted by the light-emitting member is refracted or reflected by the light guiding column.

2. The light guiding structure as claimed in claim 1, wherein the light guiding column is provided at the substantial center of the printed circuit board.

3. The light guiding structure as claimed in claim 1, wherein the light guiding column is transparent or semi-transparent, and a screw hole having screw threads is provided at the bottom end of the light guiding column, so a screw can be served to retain the light guiding column on the printed circuit board.

4. The light guiding structure as claimed in claim 1, wherein the column member of the light guiding column is a round column or a polygonal column; an arc-shaped surface that is gradually expanded is respectively defined at two ends of the middle portion of the light guiding column, and the arc-shaped surface has a top section.

5. The light guiding structure as claimed in claim 4, wherein the top section is in a cone shape, or in a cone shape and the top end of the top section is cut so a plane is defined, or in a round-column shape or in a round-column shape and the top end of the top section has plural cut angles.

6. The light guiding structure as claimed in claim 5, wherein the arc-shaped surface and the top section are provided with a diamond structure having plural cut angles for refracting or reflecting lights.

7. The light guiding structure as claimed in claim 1, wherein the quantity of the light-emitting member is three and the three light-emitting members are respectively disposed at the periphery of the light guiding column with an equal interval.

8. The light guiding structure as claimed in claim 1, wherein the light-emitting member is a LED.

9. The light guiding structure as claimed in claim 1, wherein the light guiding structure is further provided with a lamp seat and a lampshade, wherein the lamp seat is served to retain the printed circuit board and the lampshade is served to cover on top of the printed circuit board and the lamp seat, so the lampshade is not only served to allow lights emitting out but also served to protect the light guiding structure.
